(19) United States
(12) Patent Application Publication
(10) Pub. No.: US 2016/0171443 A1
(43) Pub. Date: Jun. 16, 2016

(54) METHOD FOR PREVENTING IMPROPER REPOSSESSION OF PERSONAL PROPERTY AND A SYSTEM FOR IMPLEMENTING THE METHOD

(71) Applicant: Steven Craig Roberts, Virginia Beach, VA (US)

(72) Inventor: Steven Craig Roberts, Virginia Beach, VA (US)

(21) Appl. No.: 14/568,225

(22) Filed: Dec. 12, 2014

(51) Int. Cl. G06Q 10/10; G06F 17/30

(52) U.S. Cl. CPC G06Q 10/103; G06F 17/30879; G06Q 40/02

(57) ABSTRACT

A method and system whereby a repossession contractor (e.g., a tow truck driver) may determine the current status of repossession order prior to executing a repossession order to recover a vehicle. A repossession contractor is provided a multi-modal automated unified repossession order check system that allows a repossession contractor preferably to scan a QR code on a repossession order using a cellular telephone that connects the driver's cellular phone to a central database that is queried. One of two responses is provided. If the repossession order is still valid, a bold, green message tells the repossession contractor to proceed with recovery. Alternately, if the repossession order has been rescinded, a bold red message is displayed telling the repossession contractor to discontinue recovery of the affected vehicle. The repossession contractor may alternately text or call an automated response number, or go to a website to check the repossession order.

### FIELD OF THE INVENTION

The invention pertains to repossession of property and, more particularly, to a system and method of minimizing improper repossession of property wherein a repossession contractor may ensure that a repossession order is still valid just prior to executing the repossession order to recover a vehicle or other property.

### BACKGROUND OF THE INVENTION

The term repossession refers to a process whereby a lienholder or lender may regain possession of a particular piece of property when the borrower or lendee fails to make a contractual payment on the loan for which the particular piece of property is pledged as collateral for the loan. While the repossession process may be used across a wide range of different property types, the process is particularly well known in the field of motor vehicles. The motor vehicles may have been either purchased or leased.

Motor vehicle lenders typically place loans into a pre-charge off category when the loan is in default for a statutory time period that may vary from state to state in the United States. Repossession laws in other countries may vary considerably but the principles are very much the same as in the United States.

If a loan continues to be in default for an additional period, typically ninety days, the loan is then placed in a post-charge off category. Whether the lender attempts to repossess a vehicle themselves or the task is outsourced to a third party such as skip tracing and/or forwarding entities, ultimately an independent repossession company is typically required to find and recover (e.g., tow) the vehicle.

In the majority of recoveries (i.e., repossessions), the repossession order is typically sent by the lender to the repossession agency via email, File Transmission Protocol (FTP), or directly loaded or integrated into an agency's repossession management system, etc. As used hereinafter, the term “email” is used to represent any possible electronic file or information transfer method or mechanism. Alternately the repossession order is received by the repossession agency by logging into the lender's or third party skip tracing company's system. Once the repossession order is in the repossession agency's central office, it is typically printed as a repossession order that is distributed to their own drivers or third party drivers. The repossession orders then typically end up on a clip board in a tow truck with a specific driver. If there are three shifts, three drivers of a single tow truck could conceivably each have their own clipboard with paper repossession orders.

There are several reasons why the status of a lien may change and the change may not have yet caught up with a repossession order. First, a customer (i.e., borrower) may make a payment after a repossession order has been issued. Also, the lenders lien on the vehicle may have been fraudulently or properly transferred to another party since the issuance of the repossession order. In these cases the original repossession order is no longer legally executable needs to be recalled. While an email can be sent to the repossession agency's office or posted in the on-line system, the paper order may remain out in a tow truck on a clipboard. This results in “wrongful repossessions”. While great care is taken in the industry to avoid wrongful repossessions, it is possible that a tow truck driver may not be aware that the repossession order is no longer valid. There is no effective, real time mechanism by which tow truck drivers may check the status of a particular repossession order for a vehicle prior to towing that vehicle. Validation via a phone call to a live operator is both expensive and time consuming as there is no guarantee that a driver can reach an operator at any particular time and he or she may have to wait until the status of the repossession order is verified.

Because the consequences arising from wrongful repossession may be severe (e.g., major financial cost, legal action, embarrassment, and loss of business credibility, etc.), no one in the industry wants to have to deal with such an outcome.

It would, therefore, be advantageous to provide a system whereby a tow truck driver or other appropriate repossession agent could quickly and effectively review the instantaneous status of a repossession order prior to executing that order to recover a vehicle or other property.

### DISCUSSION OF THE RELATED ART

Several attempts to overcome the problems caused by a wrongful repossession may be found in the prior art.

United States Published Patent Application No. 2003/0154119 for ONLINE METHOD AND SYSTEM FOR ISSUING VEHICLE REPOSSESSION ASSIGNMENTS TO VEHICLE REPOSSESSION CONTRACTORS, published Aug. 14, 2003 upon application by Jason Stoliker et al., discloses an online method and system for issuing vehicle repossession assignments to vehicle repossession contractors. The invention includes at least one server computer configured to host a secure online account for a vehicle repossession contractor. The online account is remotely and securely accessible by the contractor and maintains at least one vehicle repossession assignment assigned to the contractor. Vehicle repossession agents access the server computer, define contractor profiles and assign new vehicle repossession assignments to contractors via the contractor's online accounts. Contractors remotely access their online accounts to receive new repossession assignments, accept or reject the assignments, and input feedback regarding a completed repossession assignment. Server computer may be additionally configured to page or otherwise initiate notification to a contractor that a new repossession assignment is pending at the contractor's online account.

United States Published Patent Application No. 2013/0132141 METHODS AND A SYSTEM FOR IMPLEMENTING BUSINESS PROCESS MANAGEMENT FOR LONG-TERM EXECUTION PROCESSES, published May 23, 2013 upon application by Hubert Delany et al., shows a method for executing long-term business process includes steps of: a) providing an interface to design or modify a BPM diagram for at least one business process; b) providing at least one data structure to store specification and/or requirements of the BPM diagram and state of at least one BPM case/instance; c) receiving an incremental change to the BPM diagram; d) implementing based on a first set of rules, the incremental change into the BPM diagram; and e) translating the state of the BPM case/instance from a first condition to a second condition based on: i) the BPM diagram incorporating the implemented at least one incremental change; and ii) a second set of rules.

United States Published Patent Application No. 2005/0149374 for TOW MANAGEMENT SYSTEM, published Jul. 7, 2005 upon application by Sushil K. Garg provides a software based method and apparatus for managing all aspects of the tracking and dispatch industry, and in particular managing all aspects of a vehicle tow. The present invention allows a tower with a computer connection to use the computer connection to access a database that is maintained by a third party. Additionally, the system of the present invention integrates lien sale information with tow management information. The present invention is java based and utilizes click and drag features. Additionally, the software and system of the present invention allows for integration with other dispatching software packages.

United States Published Patent Application No. 2006/0293842 for VEHICLE RECOVERY SYSTEM AND METHOD, published Dec. 28, 2006 upon application by Roy Casino, shows a method and system for recovering a vehicle that is being operated without authorization. The current position of the vehicle is determined relative to a road network. Then, a recovery action is taken that takes into account the current position of the vehicle. The recovery action may include stopping the vehicle, slowing down the vehicle, or some other action. The recovery action may be deferred until the vehicle is determined to be on a road where taking the recovery action is appropriate.

None of published patent applications, taken singly, or in any combination are seen to teach or suggest the method of the present invention whereby a tow truck driver can determine an up-to-date status of a repossession order prior to executing a recovery.

### SUMMARY OF THE INVENTION

In accordance with the present invention there is provided a method and system whereby a tow truck driver can determine an up-to-date status of a repossession order prior to executing a recovery. A tow truck driver is provided a multi-modal Automated Unified Tow Order Check™ (AUTO Check™) both trademarks of Portfolio Recovery Associates, Inc. of Norfolk, Va., USA. The AUTO Check™ system allows a tow truck driver to preferably scan a Quick Response (QR) code printed on a repossession order using a cellular telephone or similar appliance that connects the driver's cellular phone to a central database. The database is queried and one of two responses is provided to the tow truck driver. If the repossession order is still valid, a bold, green message is displayed telling the tow truck driver to proceed with recovery. Alternately, if the status of the repossession order has been rescinded, a bold red message is displayed telling the tow truck driver to discontinue recovery of the affected vehicle. The tow truck driver may text or call an automated response number, or go to a website. After entering certain information, typically a portion of the vehicle identification number (VIN) and some portion of the license plate, a similar go/no-go message is provided.

While the novel system in accordance with the invention is used by banks or other lending institutions that have an equity or security interest in the vehicle to be recovered or repossessed, the system is also useful in a wide variety of other situations, circumstances, and/or environments. For example, municipalities (e.g., cities, towns, villages, boroughs, etc.), toll road operators, or third party collection agencies desiring to process a vehicle for unpaid parking tickets or citations may use the novel system. The same system is also useful to notify an owner, process vehicles, or impound vehicles. The system may need to verify the status of a repossession order differently, the system operating principle is the same.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1A is a replica of a typical repossession order;

FIG. 1B is a “Call-To-Action” panel from a repossession order;

FIG. 2 is a flow chart of the AUTO check™ system in accordance with the invention;

FIG. 3 is a simplified system block diagram of a system for implementing the method of FIG. 2;

FIG. 4A is a screen shot received in response to scanning a QR code for a rescinded repossession order, and

FIG. 4B is a screen shot received in response to scanning a QR code for a currently in-force repossession order.

### DETAILED DESCRIPTION OF THE PREFERRED EMBODIMENT

The present invention provides a method and system allowing a repossession agent to verify the status of a repossession order immediately prior to executing that repossession order to recover a motor vehicle or other property. As used herein, the term motor vehicle is intended to include motorcycles, recreational vehicles (RVs), boats, so-called four wheelers, and other off road vehicles. It will be recognized that the novel method and system of the present invention may be used with categories of repossession other than motor vehicles. Consequently, as used herein, the term “tow truck driver” is intended to refer to a repossession agent generically.

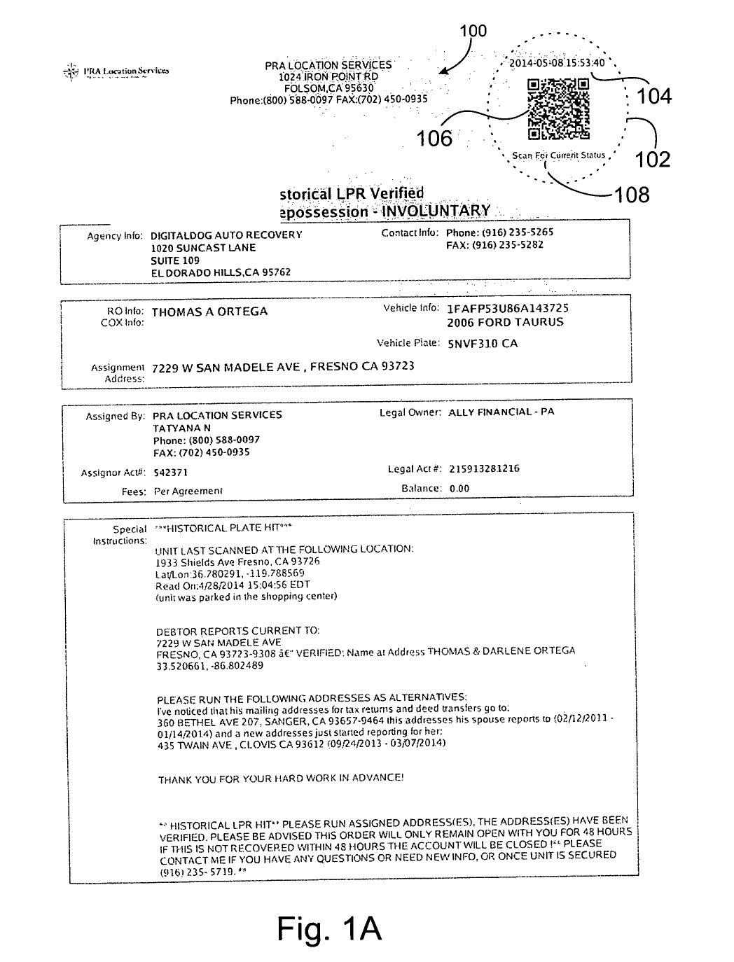

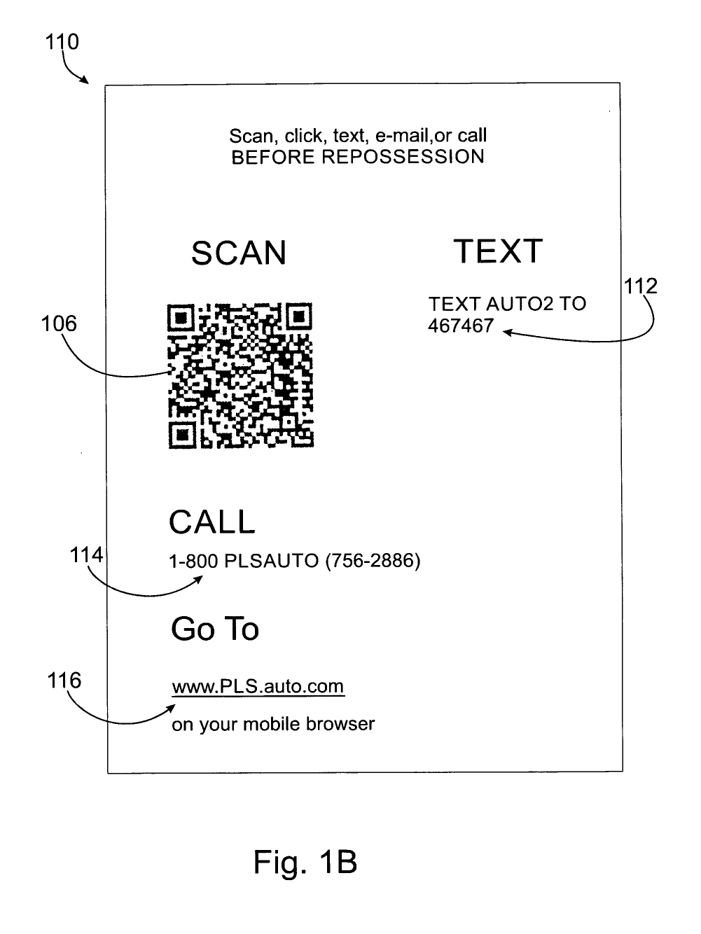

Referring first to FIG. 1A, there is shown a replica of a typical repossession order 100 of the type provided to a repossession agent, (i.e., in the case of a motor vehicle, a tow truck driver). As the content of repossession order 100 is believed to be well understood by those of skill in the art, the content of repossession order 100 is not further discussed herein.

An information area 102 in the upper right-hand corner of repossession order 100 contains a date and time stamp 104 showing when repossession order 100 was generated or printed, a well-known Quick Response (QR) code 106 that encodes some of the information on repossession order 100, and finally, an instructional note 108.

Under ideal circumstances, a tow truck driver will have available a so-called “smart phone” or other electronic appliance having a QR scanner and be in an area with an adequate cellular or other signal. He/she can then follow the instruction 108 and directly scan QR code 106. The operation of QR codes, for example QR code 106, is also believed to be well known to those of skill in the art.

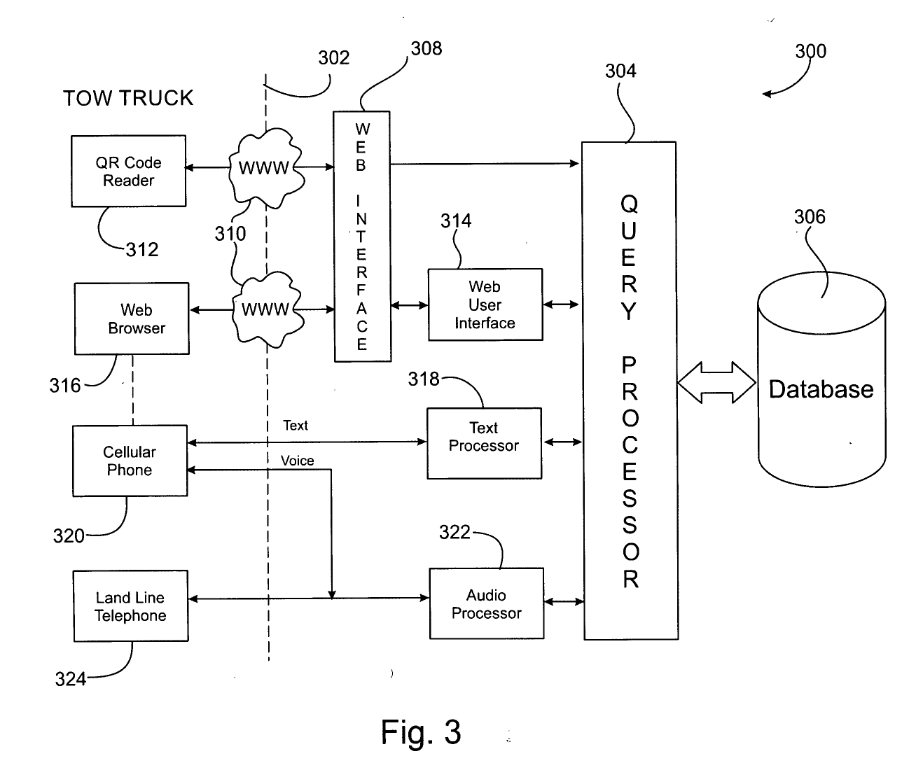

Scanning QR code 106 connects the tow truck driver with a predetermined URL (Uniform Resource Locator) code that is more colloquially known as a “web address” that will automatically connect the tow truck driver with the embedded predetermined web address. Information encoded in the QR code 106 related to the item (i.e., vehicle) being repossessed is automatically provided to a central clearing system 300 (FIG. 3).

Referring now also to FIG. 1B, there is shown an expanded version of information area 102, generally at reference number 110. While information area 110 contains QR code 106, it offers several alternative options to the tow truck driver. The tow truck driver is given all necessary information to allow him or her to text, (112), call, (114), or visit a web page, (116) to initiate a call-to-action. A call-to-action is the name given to the process of performing a final status check on the item to be repossessed described in repossession order 100.

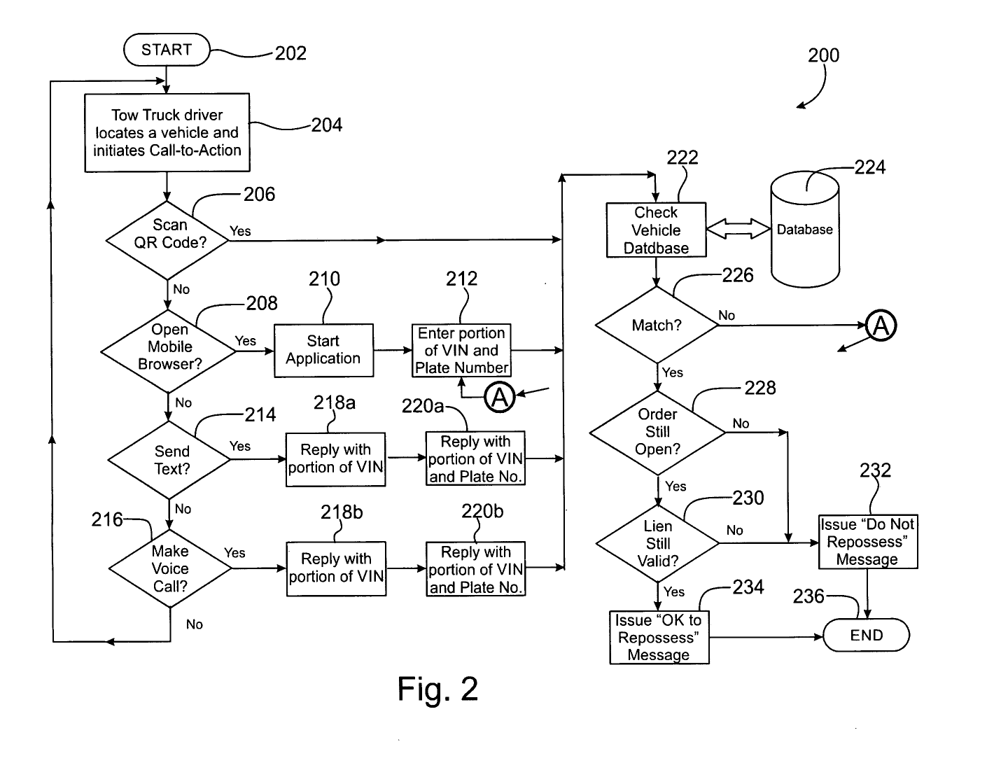

Referring now to FIG. 2, there is shown a simplified flow chart of the call-to-action process in accordance with the invention, generally at reference number 200.

The process is started, block 202.

The repossession agent (e.g., tow truck driver) locates a vehicle or other property to be repossessed and then initiates the call-to-action process, block 204.

Ideally, the tow truck driver has a mobile device, for example, a “smart” cellular phone or other similar electronic appliance that incorporates a QR scanner. If a QR scanner is available, the QR code 106 on repossession order 100 is scanned, block 206.

If the QR code is successfully scanned, control is transferred to block 222. Otherwise control is transferred to block 208.

If the tow truck driver chooses to use a mobile browser, he or she does so, block 208, and control is transferred to block 210. The tow truck driver then starts the application and first enters information from repossession order 100, block 212. Typically, the last six digits of the VIN number and the last six digits of the vehicle plate number are entered.

It will be recognized that if property other than a vehicle is being repossessed, other identifying information related to the particular type of property may be substituted for the VIN and plate number of a vehicle. Also, other portions of a VIN or plate number may be chosen. Consequently, the invention is not considered limited to a VIN and plate number or any other particular identifying information. Rather, the invention is intended to include any and all relevant identifying information, either in its entirety or any portion thereof.

After entering typically, the last six digits of the VIN number and the last six digits of the vehicle plate, control is transferred to block 222.

If the tow truck driver does not choose to use a mobile browser, block 208, control is transferred to block 214.

If the tow truck driver chooses to send a text message, block 214 to initiate a call-to-action, block 216, control is transferred to block 218a. The tow-truck driver receives a text message requesting a first piece of identifying information, block 218a. The tow truck driver responds (i.e., sends a text message) with the requested information.

Typically, the tow truck driver is sent an additional text message requesting a second piece of identifying information to which the tow truck driver responds with a second text message, block 220a. Control is then transferred to block 222,

Finally, if the tow truck driver chooses to make a voice call, block 216, control is transferred to block 218b. The tow truck driver is requested to speak a response for an auditory request for a first piece of identifying information, block 218b.

Typically, the tow truck driver receives an additional auditory request for a second piece of identifying information to which the tow truck driver also speaks a response, block 220b. Control is then transferred to block 222,

However, if no choice for initiating a call-to-action, control is transferred to block 204.

In response to choosing either text, block 214 or voice, block 216), the tow truck driver must respond, either by text message or voice response with information from repossession order 100, typically, the last six digits of the VIN number must be entered, block 218a, 218b, respectively.

After texting or responding by voice the VIN information, block 218a, 218b the last six digits of the plate number is next texted or spoken, block 220a, 220b, respectively. Control is then transferred to block 222.

At block 222, the information received automatically from scanning QR code 106 (block 206), or manually entered by using a web browser (block 208), by texting (block 214), or by voice (block 216), and typically consists of at least a portion of a VIN and plate number is presented as a query to database for a match to the information from the repossession order 100.

If a match is not found, block 226, control is returned to block 212 for reentry of VIN and plate number information.

If a match is found, block 226, information from database 224 is checked to determine if repossession order 100 is still open, block 228. If repossession order 100 is still open, control is transferred to block 230. Otherwise, control is transferred to block 232.

Assuming that repossession order 100 is still open, block 228, a final check is made to determine if the lien still valid, block 230. If the lien is still valid, block 230, control is transferred to block 234 and an “OK to Repossess” message is sent to the tow truck driver. Otherwise, control is transferred to block 232 and a “Don't Repossess” message is sent to the tow truck driver.

The process is then ended. Block 236.

Referring now also to FIG. 3, there is shown a greatly simplified system block diagram of a system providing an infrastructure for implementing the method shown in FIG. 2 and described in detail hereinabove, generally at reference number 300.

The system 300 is divided into two sections by dashed line 302, portions of the system 300 to the right of dashed line 302 belonging to a central processing facility while portions of system 302 to the left of dashed line 302 being disposed remotely, for example, in a tow track.

A query processor 304 forms a central part of system 300 and may consist of software, firmware, and hardware components configured and adapted to receive queries, format queries, present formatted queries to a database 306, retrieve responses from database 306, format output information retrieved from database 306 and present formatted output information back to users (i.e., repossession agents).

Database 306 contains detailed information on repossession orders and the status of liens associated with an item such as a vehicle scheduled to be repossessed. Such databases are believed to be well known to those of skill in the art and, consequently, are not further described or discussed herein. Further, database 306 is assumed to contain up-to-date data and the information in database 306 is kept current by means unrelated to the invention and not further discussed herein.

Query processor 304 receives information from and returns information to four different sources via bi-directional interfaces. Information is received from sources including: a QR code scanner 312, via the World Wide Web (WWW) also known as the Internet depicted as cloud 310 via a web interface 308.

Another information source is, from a web user interface 314 via web interface 308, WWW 310 from a web browser 316.

Another information source is from a text processor 318 originated by a text communication from a cellular phone 320.

A final information source is from an audio processor/audio response unit 322 and originating from either a cellular phone 320 of another type of phone such as a land line phone, satellite phone, etc.

Each of the components web interface 308, web user interface 314, text processor 318, and audio processor/audio response unit 322 are all assumed to contain all necessary communications functionality to perform their intended tasks.

If the tow truck driver chooses to initiate a call-to-action via a mobile web browser, the connection between web browser 316 passes through WWW 310, web interface 308 and a web user interface 314 is activated for two-way communication with the tow truck driver.

If a cellular phone is chosen by the tow truck driver to initiate a call-to-action, he or she may choose a voice mode or a text mode for communication.

If a text communication is chosen, interaction is between cellular phone 320 and a text processor interface 318.

Alternately, if voice mode communication is chosen, communication is between cellular phone 320 and an audio processor/response unit 322.

All components forming the novel system topology 300 are assumed to be known to those of skill in the art. Typically off-the-shelf technology may be used to form any or all of the functional components of system 300. Alternately, some or all of the system 300 components may be custom designed and/or built to perform the intended function as described herein.

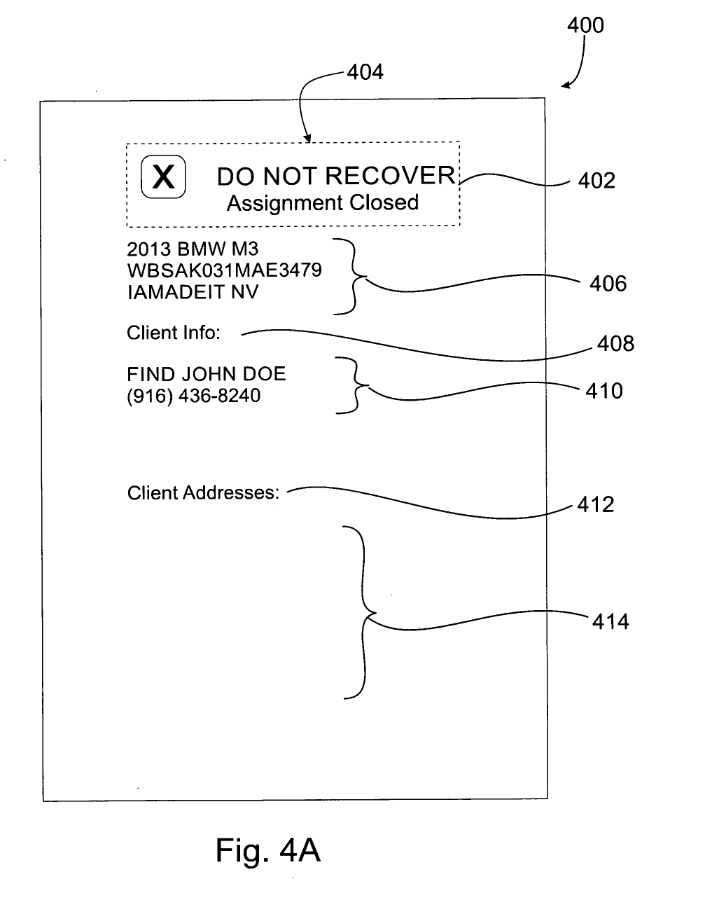

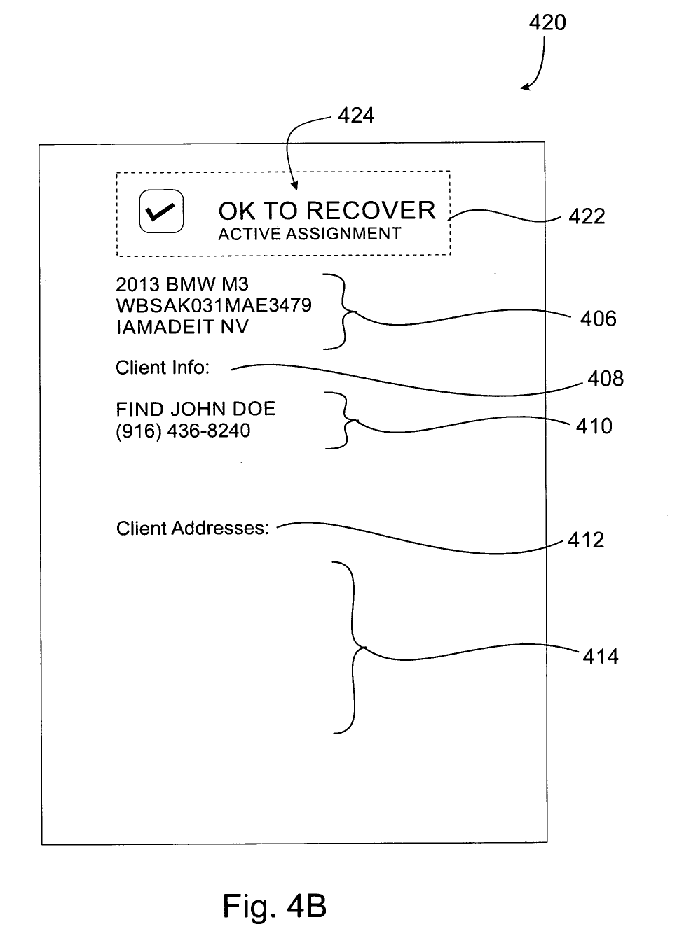

Referring now also to FIG. 4A, there is shown a typical screen shot in response to scanning a QR code for a rescinded repossession order, generally at reference number 400.

Screen shot 400 has a region 402 at the top of the screen denoted by dashed rectangle 402 that is typically shown in red. Information 404 informs the tow truck driver that the repossession order has been rescinded and that repossession efforts are to be abandoned.

The remainder of the screen shows information on the vehicle that was to have been repossessed 406, the client information screen header 408, the client information 410, the client address header 412, and any available address information (none shown) 414.

Finally, referring now also to FIG. 4B, there is shown a screen shot in response to scanning a QR code for a currently in-force repossession order, generally at reference number 420.

Like FIG. 4A, a screen area 422 denoted by dashed rectangle 422 is typically displayed in green and the information 424 indicates to the tow truck driver that it is OK to continue his or her repossession effort.

Also like FIG. 4A the remainder of the screen shows information on the vehicle that was to have been repossessed 406, the client information screen header 408, the client information 410, the client address header 412, and any available address information (none shown) 414.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of minimizing erroneous repossession of an object, the steps comprising:
a) issuing a repossession order for an object, said repossession order comprising identifying information related to said object and at least a QR code containing at least said identifying information;
b) conveying said repossession order to a repossession agent;
c) locating said object in preparation for repossessing by said repossession agent;
d) prior to repossessing said object, said repossessing agent initiating a call-to-action process comprising the sub-steps:
i) scanning said QR code;
ii) in response to scanning said QR code, automatically checking information embedded in said QR code against a database and determining if said repossession order is still valid and, if said repossession order is still valid, checking that any lien associated with said object is still outstanding;
iii) if said repossession order is still valid and if said lien against said object is still outstanding, conveying a message to said repossession agent and instructing him/her to repossess said object;
iv) if at least one condition selected from the group: said repossession order is no longer valid, and said lien against said object is no longer outstanding, conveying a message to said repossession agent and instructing him/her to discontinue repossession efforts.

2. The method of minimizing erroneous repossession of an object as recited in claim 1, wherein said issuing step (a) further comprises issuing a repossession order for an object, further comprises indicia containing instructions for means other than scanning said QR code for initiating a call-to-action.

3. The method of minimizing erroneous repossession of an object as recited in claim 2 wherein said issuing step (a) further comprises issuing a repossession order wherein said indicia comprises at least one instruction for initiating a call-to-action selected from the group: instructions for using a web browser, instructions for using a cellular phone to send a text message, instructions for using a cellular phone to make a voice call, and instructions for using a phone other than a cellular phone to make a voice call.

4. The method of minimizing erroneous repossession of an object as recited in claim 3 wherein said initiating a call-to-action step (d) comprises the sub-steps:
d) prior to repossessing said object, said repossessing agent initiating a call-to-action process comprising the sub-steps:
i) following one of said instructions selected from the group: using a web browser, using a cellular phone to send a text message, using a cellular phone to make a voice call, and using a phone other than a cellular phone to make a voice call;
ii) when requested, entering at least some of said information associated with said object being repossessed;
iii) in response to said entering sub-step (ii), automatically checking said entered information against a database and determining if said repossession order is still valid and, if said repossession order is still valid, checking that any lien associated with said object is still outstanding;
iv) if said repossession order is still valid and if said lien against said object is still outstanding, conveying a message to said repossession agent and instructing him/her to repossess said object;
v) if at least one condition selected from the group: said repossession order is no longer valid, and said lien against said object is no longer outstanding, conveying a message to said repossession agent and instructing him/her to discontinue repossession efforts.

5. A system for possessing a call-to-action initiated by a repossession agent, comprising:
a) a database comprising up-to-date identification information relating to an object being repossessed;
b) a query processor operatively connected to said database and disposed to formulate and present a query to said database;
c) a web interface bi-directionally connected to said query processor and to the Internet;
d) a QR code scanner located remotely from said database, said query processor, and said web interface and operatively connected to the Internet;
whereby a QR code on a repossession order associated with said object being repossessed is transmitted to said web interface via said Internet, processed by said query processor, and presented as a query to said database that in turn determines if said object may be repossessed.

6. The system for possessing a call-to-action initiated by a repossession agent as recited in claim 5, further comprising:
e) a web user interface disposed between said query processor and said web interface and disposed for bi-directional, interactive communication with a web browser located remotely therefrom via said Internet; and
f) application software comprising instructions executable by said web user interface.

7. The system for possessing a call-to-action initiated by a repossession agent as recited in claim 5, further comprising:
e) a text processor bi-directionally connected to said query processor and adapted to receive a text message via a cellular communications network.

8. The system for possessing a call-to-action initiated by a repossession agent as recited in claim 5, further comprising:
e) an audio processing unit operatively connected to said query processor and adapted for receiving voice communication via at least one of the transmission mechanisms: a cellular communications network, and a non-cellular telephonic communications network; and
f) an audio response unit operatively connected to said audio processing unit for providing an audio response to a remotely located user via at least one of the transmission mechanisms: a cellular communications network, and a non-cellular telephonic communications network.
